(19) United States
(12) Patent Application Publication
(10) Pub. No.: US 2005/0212303 A1
(43) Pub. Date: Sep. 29, 2005

(54) Motor vehicle lock with noise-optimized latching elements

(75) Inventor: Simon Brose, Hattingen (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH & Co. KG, Wuppertal (DE)

(21) Appl. No.: 11/087,613

(22) Filed: Mar. 24, 2005

(30) Foreign Application Priority Data
Mar. 24, 2004 (DE) 10 2004 014 805.8

(51) Int. Cl. E05C 3/06

(52) U.S. Cl. 292/216

(57) ABSTRACT

Motor vehicle lock, with a latch with a main catch and optionally a preliminary catch and with a ratchet with a catch projection which engages with the latch at the main catch and optionally the preliminary catch, and segments of the latch and of the ratchet which engage one another being made of metal, and otherwise being jacketed with a plastic material or made of a plastic material. Noise development is reduced by the plastic material of the latch and the ratchet being widened into a buffer plane next to the engagement plane and the plastic material of the latch and the ratchet being arranged and shaped in the buffer plane such that, except for the engagement of the catch projection on the main catch, and optionally the preliminary catch of the latch, noise-relevant contact of the latch and the ratchet takes place only in the buffer plane.

### BACKGROUND OF THE INVENTION

1. Field of Invention

The invention relates to a motor vehicle lock with noise-optimized latching elements, such as a latch and ratchet, which is made especially as a rotary latch, with a main catch and optionally a preliminary catch and with a ratchet with a catch projection which engages with the latch in the main catch and optionally in the preliminary catch, the main catch and, if present, the preliminary catch of the latch with the catch projection of the ratchet lying in the same plane and at least the segments of the latch and of the ratchet which engage one another being made of metal, the latch and the ratchet otherwise being jacketed with a plastic material or being made of a plastic material and optionally the plastic material being made or set to be soft elastic in areas and/or buffer chambers being made in the plastic material with and without filling of soft elastic damping material.

2. Description of Related Art

Motor vehicle locks of the type under consideration are locks for side doors, rear doors, and rear hatches, but also for other closure elements in motor vehicle bodies. Motor vehicle locks are a component of great relevance to safety engineering, especially for the side doors of motor vehicle bodies. To keep a motor vehicle door closed, for example, in an accident, the latching elements, generally a latch which is made as a rotary latch and a ratchet which keeps it in the main latching position, are the decisive components. For reasons of reliable accommodation of the opening forces which arise, the latch and the ratchet are generally made of high-strength steel.

Normally, a motor vehicle lock for the side door of a motor vehicle body has a main latching position, but in front of the latter, however, a pre-latching position in which the motor vehicle door is not completely closed, but is temporarily secured. It is used for additional safety. The main latching position is implemented by the engagement of the ratchet on the main catch of the latch, the pre-latching position is reached when the catch projection of the ratchet locks in the preliminary catch of the latch.

Attempts have been underway for a long time to reduce the noise development of a motor vehicle lock when the motor vehicle door is opened and closed. The established means for doing this is to jacket the latch and ratchet with a plastic material (German Patent Application DE 23 20 351 A1). At noise-relevant contact points of the latch which is made as a rotary latch and of the ratchet, in addition, in the plastic material of the jacketing, there are buffer chambers which are formed by recesses and projections. In this way, when using the same plastic material for all the jacketing, different characteristics, especially different hardness and deformation paths, can be implemented. This concept has already been developed such that the buffer chambers are provided in areas with a filling of elastic damping material (German Patent Application DE 102 16 313 A1). This changes nothing in the basic principle of this design.

With the above explained concept of jacketing of the latch and ratchet with plastic material which is known from the prior art, optionally with the formation of buffer chambers with and without filling, major progress has already been made with respect to noise development when the motor vehicle door is opened and closed. Since then, noise development has originated largely from the locking of the catch projection on the main catch and the preliminary catch which inevitably involves metal striking metal. The molding-engineering possibilities of producing plastic jacketing make it necessary to keep a minimum area on the main catch and the preliminary catch and on the catch projection of the ratchet free of plastic material so that, in any case, keeping the motor vehicle lock closed on the main catch and the preliminary catch by the metal areas catching in one another is ensured.

### SUMMARY OF THE INVENTION

A primary object of the present invention is to embody and develop the above explained, known motor vehicle lock with respect to the latching elements, such that noise development is reduced further during opening and closing relative to the prior art.

This object is achieved in a motor vehicle lock of the initially mentioned type by the plastic material of the latch and of the ratchet being widened into a buffer plane which is located next to the engagement plane and by the plastic material of the latch and the ratchet being arranged and shaped in the buffer plane such that, except for the engagement of the catch projection of the ratchet on the main catch, and optionally the preliminary catch of the latch, noise-relevant contact of the latch and the ratchet takes place only in the buffer plane.

The heart of the teaching of the invention is to allow the latch and ratchet to make contact outside of direct contact-making on the main catch and the preliminary catch, no longer in the engagement plane, but in a buffer plane which lies parallel to it. Without the structural limitations which result from the necessities of plastic-injection molding technology, there is the option here of providing a highly noise-suppressing plastic/plastic contact surface for all possible relative positions of the latch and ratchet. In spite of this, it is possible to ensure metal/metal engagement on the main catch and the preliminary catch unchanged in the engagement plane. With the deflection into the buffer plane which is parallel to the engagement plane and in which the necessary contours are made only in the plastic material of the latch and ratchet, an additional degree of freedom is created which can be systematically used to reduce noise development when the motor vehicle lock in accordance with the invention is opened and closed.

In fact, it is such that the configuration of the plastic material of the latch and ratchet in the buffer plane can always ensure a minimum gap between the metal areas of the latch and ratchet. This gap can also by implemented on the main catch and the preliminary catch relative to the catch projection, if it is assumed that this is accomplished only without any significant external action of a force. Then, the ratchet with the catch projection, when the motor vehicle lock is being locked with the momentum of the slamming of the motor vehicle door with plastic/plastic contact in the buffer plane can engage in the main catch, and then, the resetting force of the door seal which takes effect leads to the plastic material on the latch and ratchet being deformed to such a degree that now the metal sections of the latch and ratchet on the main catch and catch projection come into direct contact with one another and ensure the desired opening forces for operation.

Furthermore, the deflection with the plastic material into an additional buffer plane parallel to the engagement plane of the latch and ratchet has the added effect that auxiliary elements, such as a switch operating cam, magnet inserts or the like can be arranged and integrated there.

The invention is explained in detail below using the accompanying drawings which show an embodiment of the invention.

### BRIEF DESCRIPTION OF THE DRAWINGS

FIG. 1 shows the basic principle of latching elements of a motor vehicle lock of the prior art,

FIG. 2 shows the basic principle for a motor vehicle lock in accordance with the invention in a representation similar to FIG. 1,

FIG. 3 is a sectional view of the motor vehicle lock taken along line III-III in FIG. 2.

### DETAILED DESCRIPTION OF THE INVENTION

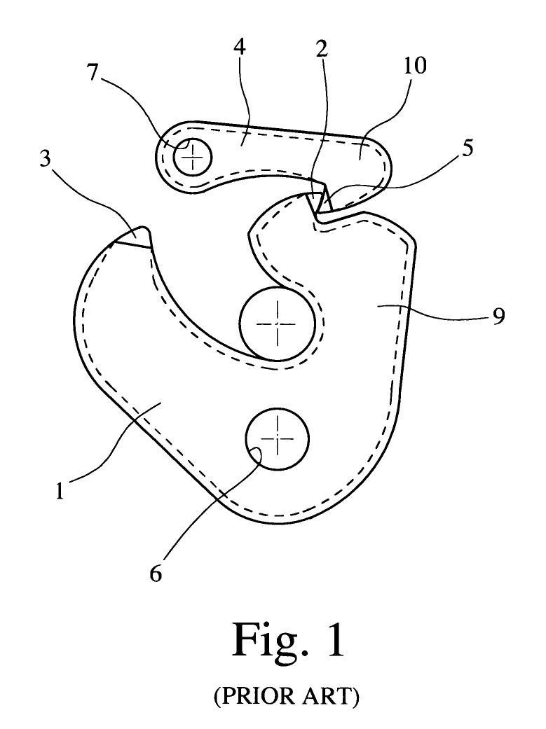

FIG. 1 shows the basic principle of a motor vehicle lock known from the prior art, with a latch 1, which is made especially as a rotary latch, with a main catch 2, and here preferably, a preliminary catch 3, and with a ratchet 4 with a catch projection 5 which engages with the latch 1 at the main catch 2 and at the preliminary catch 3. The latch 1 is supported by means of a bearing sleeve 6 on the rear sheet metal of the motor vehicle lock (not shown); likewise, the ratchet 4 is supported by means of a bearing sleeve 7. The ratchet as shown here is a tension-loaded ratchet 4. In the corresponding manner, there are also compressively loaded, accordingly shorter ratchets. Reference should be made to the prior art in this respect (German Patent Applications DE 23 20 351 A1 and DE 102 16 313 A1).

As usual, here, it is also such that the main catch 2 and the preliminary catch 3 lie and move in one plane with the catch projection 5 of the ratchet 4, i.e., the engagement plane 8 (FIG. 3). At least the segments of the latch 1 and the ratchet 4 which engage one another, therefore the main catch 2, the preliminary catch 3 and the tip of the catch projection 5 are made of metal in order to be able to ensure the necessary locking pressures, as already explained above. This can be done by the latch 1 and the ratchet 4, as shown here, being made of metal and being jacketed simply with a plastic material 9, 10. However, this can also be done such that the latch 1 and/or the ratchet 4 are made of a fiber-reinforced plastic material and are provided only with metallic inserts at the corresponding points. Overall, reference should be made to the different versions which are known in the prior art (see, European Patent Application EP 0 917 614 A1 and U.S. Pat. No. 6,209,932 which corresponds thereto).

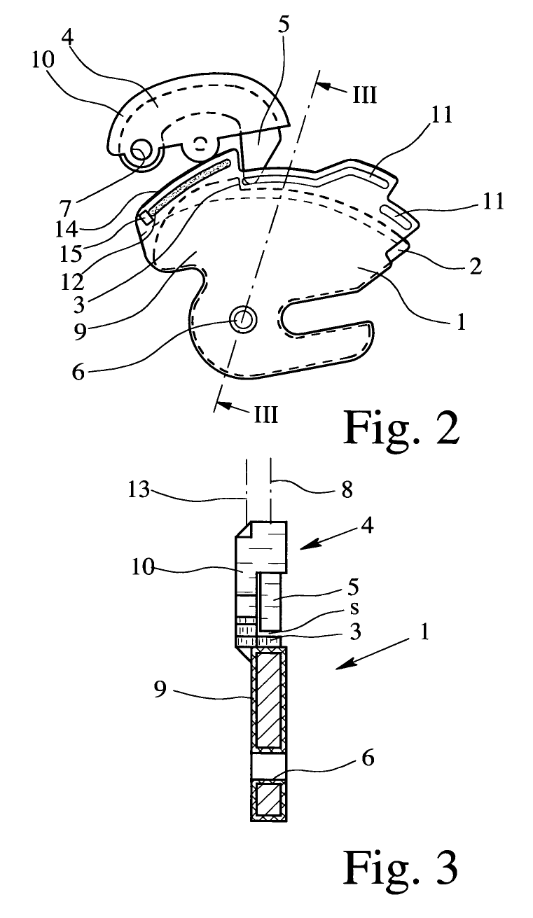

FIG. 2 shows one embodiment of the motor vehicle lock in accordance with the invention, more accurately the latching elements of such a motor vehicle lock. The reference numbers which have already been explained are used here to facilitate comparison.

As is known in the prior art, to reduce the impact noise, the plastic material 9, 10 is made or set to be soft elastic in areas and/or the buffer chambers 11 are made in plastic material 9, 10 with and without a filling 12 of soft elastic damping material. Reference should be made to German Patent DE 102 16 313 A1 for detailed explanations of this concept.

It is significant to the invention that the plastic material 9, 10 of the latch 1 and the ratchet 4 is widened into a buffer plane 13 which is located next to the engagement plane 8 and that the plastic material 9, 10 of the latch 1 and the ratchet 4 is arranged and shaped in the buffer plane 13 such that, except for the engagement of the catch projection 5 of the ratchet 4 on the main catch 2 and optionally the preliminary catch 3 of the latch 1, all contact of the latch 1 and the ratchet 4 takes place only in the buffer plane 13. What is intended is apparent in FIGS. 2 & 3 in combination. By moving the contacts which are important for noise development into the buffer plane 13, which is made exclusively of plastic material 9, 10 of the latch 1 and ratchet 4, a considerable reduction of noise development as compared to motor vehicle locks of the prior art takes place. In the buffer plane 13, there are no limitations in terms of plastic-injection molding technology with respect to the metallic segments on the main catch 2, preliminary catch 3 and catch projection 5 which, in the engagement plane 8, require minimum distances for transitions from plastic to metal. These minimum distances can be greatly reduced by deflection into the parallel buffer plane 13. Even overlapping can be produced; this is explained further below.

FIG. 3 shows that the configuration of the plastic material 9, 10 of the latch 1 and the ratchet 4 in the buffer plane 13 always ensures a minimum gap s between the metal areas of the latch 1 and the ratchet 2.

With consideration of the sequences of movements which in fact occur, for example, when a motor vehicle door is being slammed, overlapping of the contact surfaces in the buffer plane 13, on the one hand, and the engagement plane 8, on the other, can even occur. If the overtravel positions which occur in operation are considered, this can result in that there is a minimum gap s on the main catch 2, and optionally, the preliminary catch 3 of the latch 1 for the normal engagement position of the catch projection 5 of the ratchet 4 essentially without the action of additional forces, and that the parameters, especially the hardness and deformation paths of the areas of the latch 1 and ratchet 4, which areas are made of plastic material 9, 10 in the buffer plane 13, are chosen such that, under the action of a force which is conventional in operation, contact of the metal segments 2, 3, 5 of the latch 1 and ratchet 4 against one another takes place. In this way, all impacts which occur with high speed proceed in the area of the buffer plane 13, while in the area of the engagement plane 8 the metal segments on the main catch 2, the preliminary catch 3 and the catch projection 5 come to rest against one another softly and quietly simply under the action of reset forces.

Finally, FIG. 2 shows that auxiliary elements, such as the switch control cam 14, magnet inserts 15 or the like in the buffer plane 13 are integrated into the plastic material 9, 10. In this respect the implementation of a parallel buffer plane 13 of the invention offers new possibilities for the configuration.

With respect to the choice of plastics for the plastic material 9, 10, on the latch 1 and the ratchet 4, reference should be made otherwise to the prior art which was addressed at the beginning.

1. Motor vehicle lock, comprising:
a latch with a main catch and
a ratchet with a catch projection which engages with the latch at the main catch,
wherein the main catch lies in the same plane with the catch projection of the ratchet
wherein at least the segments of the latch and of the ratchet which engage one another are made of metal,
wherein the latch and the ratchet are jacketed with or are made of a plastic material except for said segments,
wherein the plastic material of the latch and of the ratchet is widened into a buffer plane which is located next to the engagement plane and
wherein the plastic material of the latch and the ratchet is arranged and shaped in the buffer plane such that, except for the engagement of the catch projection of the ratchet on the main catch, noise-relevant contact of the latch and the ratchet takes place only in the buffer plane.

2. Motor vehicle lock as claimed in claim 1, further comprising a preliminary catch, and wherein the ratchet is a rotary ratchet and wherein the catch projection of the ratchet is also engageable with the preliminary catch, and wherein, except for the engagement of the catch projection of the ratchet on the main catch and preliminary catch, noise-relevant contact of the latch and the ratchet takes place only in the buffer plane.

3. Motor vehicle lock as claimed in claim 1, wherein the configuration of the plastic material of the latch and the ratchet in the buffer plane always ensures a minimum gap between the metal segments of the latch and the ratchet.

4. Motor vehicle lock as claimed in claim 3, wherein the minimum gap is on the main catch of the latch for normal engagement of the catch projection of the ratchet, and wherein physical characteristics of the areas of the latch and ratchet which are made of plastic material, in the buffer plane, are chosen such that, under the action of a force which is conventional in operation, contact of the metal segments of the latch and ratchet against one another takes place.

5. Motor vehicle lock as claimed in claim 1, wherein the plastic material is set to be soft elastic.

6. Motor vehicle lock is claimed in claim 1, wherein buffer chambers are made in the plastic material.
